(19) United States
(12) Patent Application Publication
(10) Pub. No.: US 2012/0017736 A1
(43) Pub. Date: Jan. 26, 2012

(54) POWER CORD ROUTING SYSTEM FOR MITER SAW WITH HINGE LINKAGE LINEAR GUIDE

(75) Inventors: Adam Thomas, Aurora, IL (US); Jie Liu, Lisle, IL (US); Gary Voong, Chicago, IL (US)

(73) Assignee: Robert Bosch Tool Corporation, Broadview, IL (US)

(21) Appl. No.: 13/194,687

(22) Filed: Jul. 29, 2011

Related U.S. Application Data
(63) Continuation-in-part of application No. 11/284,931, filed on Nov. 22, 2005.

(51) Int. Cl. B23D 45/04; H01B 7/00; B23D 47/00

(52) U.S. Cl. 83/471.2; 174/135

(57) ABSTRACT

A power saw includes a table configured to receive a workpiece, a saw blade and motor assembly having a motor for rotating a saw blade, and a power cord connected to the motor for supplying electric power to the motor. A linear guide mechanism is operatively connected to the table and is configured to pivotally support the saw blade and motor assembly. The linear guide mechanism enables movement of the saw blade and motor assembly along a predetermined linear path in a forward or a rearward direction, and includes at least two links connected by a hinge connection. A cord clip is rotatably fixed to the hinge connection and configured to receive a section of the power cord.

This patent is a continuation-in-part of U.S. Ser. No. 11/284,931 filed Nov. 22, 2005.

### BACKGROUND OF THE INVENTION

This patent generally relates to power miter and abrasive cut off saws.

Miter saws have been the subject of continued research and development efforts in the power tool arena for decades, and many improvements have been made that has resulted in increased ease of use and productivity. Artisans who install trim carpentry have used power miter saws for some time and it is well known that wide stock such as crown molding and the like often requires a miter saw with either a bigger saw blade or a configuration that enables the blade to be moved along a horizontal path away and toward the fence of the miter saw. Such blade moving configurations are generally marketed as sliding compound miter saws, principally because most if not all commercially available saws of this type have a sliding guide assembly comprised of elongated rods that slide in respective bushings to move the saw blade and motor assembly relative to the fence of the saw.

Such sliding guide assemblies are an expensive component of such miter saws. The current state of the art for such sliding miter saws includes a linear guide that typically consists of two of such bushings and rod combinations. These relatively expensive linear bearings consist of recirculating ball bearings that operate together with turned, ground, polished and hardened steel rods that are approximately 40 cm long and 30 mm in diameter. To have minimum play and deflection of the saw blade and motor assembly, precise fits are required between the rods and the linear recirculating ball bearings over the entire linear travel of the rods. The rod must be made of a high hardness steel to prevent indentation by the hard steel balls. Such construction is relatively expensive.

Additionally, an undesirable feature of such bushing and rod linear guides is that space must be provided behind the saw for the rods to extend when the saw blade is positioned near the fence. Because of this space requirement, such a sliding saw cannot be put next to a wall which results in a larger footprint being occupied by such a saw. Additionally, these bushings and rod linear guide mechanisms are susceptible to damage from dirt and grit, particularly if the saw is a sliding abrasive cut off saw where an abrasive wheel is used to cut steel and other materials. The abrasive wheel grinds its way through the steel and produces a considerable volume of abrasive particles that generally come out of the back of the saw. These abrasive particles can penetrate into the ball bushings and damage the bearing. While it is possible to cover the rods with a bellows or similar cover, the hostile environment generally leads to degradation of the fabric and penetration of the ball bushing by the abrasive particles.

There is a continuing need for improvement in the design and development of miter and cut-off saws that have linear guide assemblies.

### SUMMARY OF THE INVENTION

This patent is directed to a power saw having a table configured to receive a workpiece, a saw blade and motor assembly including a motor for rotating a saw blade, and a power cord connected to the motor for supplying electric power to the motor. A linear guide mechanism is operatively connected to the table and is configured to pivotally support the saw blade and motor assembly. The linear guide mechanism enables movement of the saw blade and motor assembly along a predetermined linear path in a forward or a rearward direction, and includes at least two links connected by a hinge connection. A cord clip is rotatably fixed to the hinge connection and configured to receive a section of the power cord.

### DESCRIPTION OF THE DRAWINGS

FIG. 1 is a right side perspective view of a first preferred embodiment of the present invention, particularly illustrating the saw blade being located in the extended position away from the fence;

FIG. 2 is a right side perspective view of the embodiment shown in FIG. 1, but illustrating the saw blade in a position near the fence;

FIG. 3 is a side elevation of the embodiment shown in FIG. 1 with the saw blade in the extended position away from the fence;

FIG. 4 is a rear view of the embodiment shown in FIG. 1, with the saw blade away from the fence;

FIG. 5 is a right front perspective view of a second preferred embodiment of the present invention, particularly illustrating the saw blade being located in the extended position away from the fence;

FIG. 6 is a right front perspective view of the embodiment shown in FIG. 5, but illustrating the saw blade in a position near the fence;

FIG. 7 is a side elevation of the embodiment shown in FIG. 5 but illustrating the saw blade in a position near the fence;

FIG. 8 is a rear view of the embodiment shown in FIG. 5, with the saw blade in a position away from the fence;

FIG. 9 is a third preferred embodiment of the present invention, particularly illustrating the saw blade being located in the extended position away from the fence;

FIG. 10 is a side elevation of the embodiment shown in FIG. 9 with the saw blade in the extended position away from the fence.

FIG. 11 is another side elevation of the embodiment shown in FIG. 9, with the saw blade near the fence;

FIG. 12 is a rear view of the embodiment shown in FIG. 9, with the saw blade located away the fence;

FIG. 13 is a perspective view of the right side of a miter saw, with the blade and motor assembly in an extended and lowered position, in accordance with another embodiment of the invention;

FIG. 14 is a perspective view of the right side of the miter saw shown in FIG. 13, with the blade and motor assembly in a retracted and lowered position;

FIG. 15 is a perspective view of the left side of the miter saw shown in FIG. 13, with the blade and motor assembly in an extended position;

FIG. 16 is a perspective view of the left side of the miter saw shown in FIG. 13, with the blade and motor assembly in the retracted and lowered position;

FIG. 17 is a top plan view of the miter saw shown in FIG. 13, with the blade and motor assembly in the retracted and lowered position and the blade being perpendicular to the fence;

FIG. 18 is a top plan view of the miter saw shown if FIG. 13, with the blade and motor assembly in the retracted and lowered position and the blade being at a miter angle to the fence;

FIG. 19 is a is a perspective view of the left side of the miter saw shown in FIG. 13, with the blade and motor assembly beveled to the left side;

FIG. 20 is a perspective view of the left side of the miter saw, showing the a power cord being routed to the electric motor, in accordance with various embodiments of the invention;

FIG. 21 is a perspective view of the left side seen from the rear of the miter saw, showing the described embodiment for routing the power cord to the electric motor, in accordance with various embodiments of the invention;

FIG. 22 is a detailed view of the power cord being routed along the linear guide mechanism of the miter saw shown in FIG. 20, in accordance with various embodiments of the invention;

FIG. 23 is a sectional view illustrating the construction of a described embodiment of clips utilized in routing the power cord, in accordance with various embodiments of the invention; and

FIG. 24 is a sectional view illustrating the construction of another described embodiment of clips utilized in routing the power cord, in accordance with various embodiments of the invention.

### DETAILED DESCRIPTION

Various different embodiments of miter saws are shown and described herein, with the each of the embodiments having a multiple hinge linkage that is designated herein as a horizontal hinge linkage that interconnects the saw blade and motor assembly to the table of the miter saw. It should be understood that while it is referred to herein as a generally horizontal hinge linkage, the several shafts of the linkage may not always be exactly horizontal, and may have a pivot axis that can vary up to about 30 degrees in either direction from exact horizontal. However, it is preferred that the axes be in a substantially horizontal orientation when the saw is set at a zero degree bevel position. Regardless of the bevel angle or the orientation of the surface on which the saw is supported, the shafts are preferably substantially parallel to the arbor shaft in which the blade is mounted and therefore substantially perpendicular to the plane of the saw blade.

The horizontal hinge linkage is utilized rather than an elongated rod and bushing configuration and provides increased stiffness to undesired movement of the saw blade arising from structural deflections during cutting operations. Some of the embodiments also have a vertical hinge linkage for maintaining the elevation of the saw pivot head (to which the saw blade and motor assembly is attached) constant during movement of the saw blade and motor assembly away and toward the fence during a cutting operation. One of the embodiments utilizes the horizontal hinge linkage together with a single rod and bushing arrangement whereby the rod and bushing arrangement also maintains a constant elevation of the saw pivot head as the saw blade and motor assembly is moved toward and away from the fence during a cutting operation. It should be understood that the saw blade and motor assembly is pivotable about a saw pivot that is part of the saw pivot head, which is attached to the horizontal hinge linkage. The saw blade and motor assembly can be pivoted up out of contact with a work piece or moved down into contact with a work piece during a cutting operation as is conventional for miter saws.

Such hinge linkages have a cost advantage compared to conventional bushing and rod guides because they have a simpler construction, which may comprise as few as two generally planar shaped linkages that are connected together by shafts that may preferably incorporate rotary bushings or low cost ball bearings and which are also linked to the support frame of the rotatable table as well as to the saw pivot head. Tight tolerance fits between hinge components are relatively easier to achieve using low cost ball bearings that are preloaded in the axial direction so that nearly all axial and radial play is removed. In contrast, conventional bushings and sliding rod systems require expensive manufacturing processes to ensure that the outside surface of the rod is precise over its entire length. Another advantage of the use of hinge linkages is that their stiffness characteristics are determined primarily from the width of the hinge linkages as measured along the pivot, i.e., shaft axis. Thus, increased system stiffness can be achieved by making the hinge larger and this is generally less expensive than using larger rods and bushings.

As previously mentioned, the horizontal hinge linkage pivots around axes that are perpendicular to the cutting plane of the blade and therefore provides increased stiffness along the axis of rotation of the saw blade and because of this desirable characteristic, the length of the hinge shafts is greater than other shaft lengths such as those used in the vertical hinge linkage. The structural stiffness is very important to the quality of cuts made by the saw. Without the requisite structural stiffness, it is common for the saw blade to deflect out of the desired cutting plane on an intermittent basis which can result in one or more cut discontinuities or jagged cut portions, rather than a continuous smooth cut at the desired angle.

Another advantage of the hinge linkage is that it has greatly reduced sensitivity to dirt and grit because the bearing surfaces of a hinge linkage are not exposed but are contained within a ball bearing or short rotary bushing. Such ball bearing or rotary bushings can be relatively easily sealed compared to a rod and bushing system where the entire rod is a critical bearing surface and therefore has to be sealed with a large accordion or bellow shaped fabric or other type of cover which is often easily damaged.

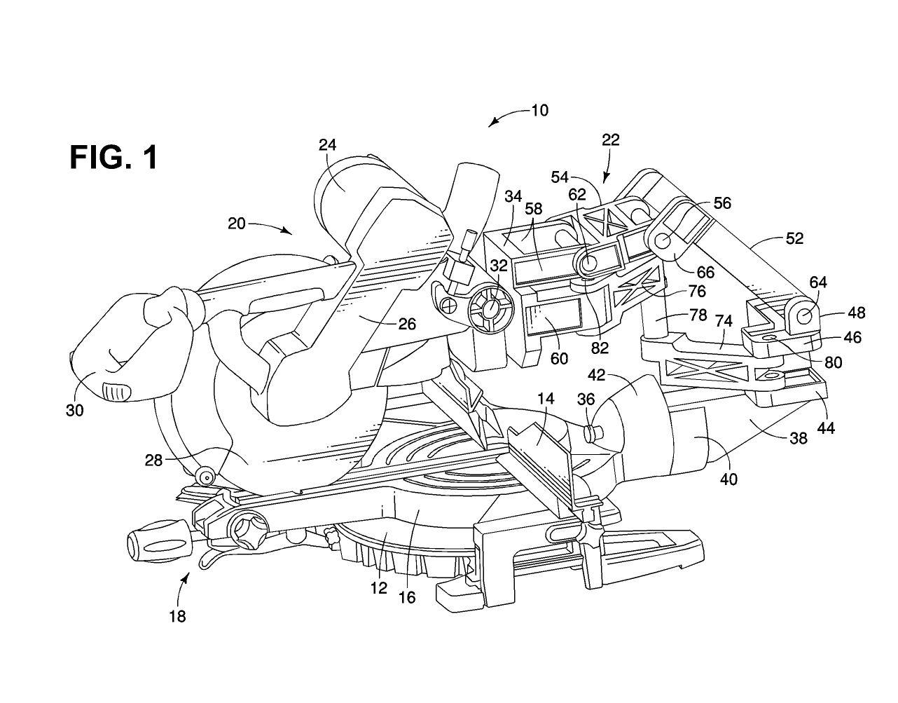

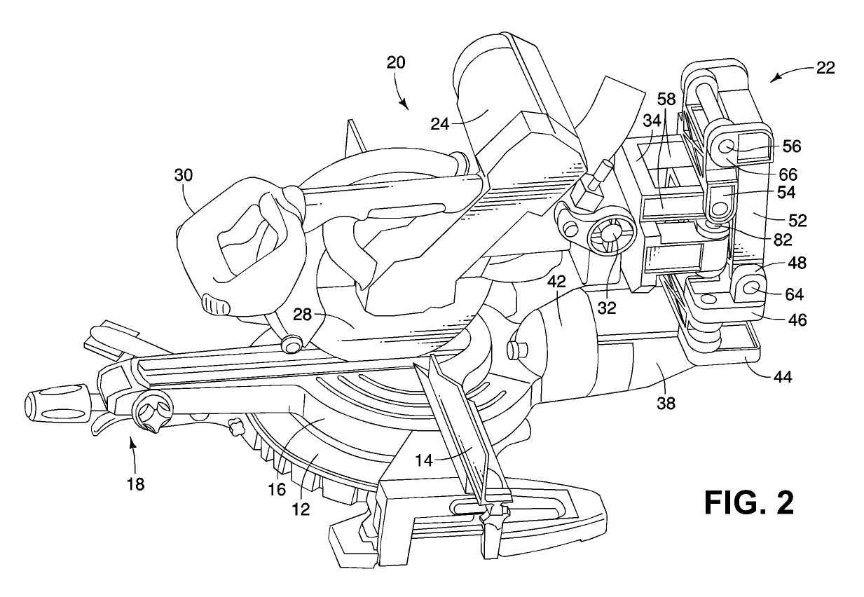

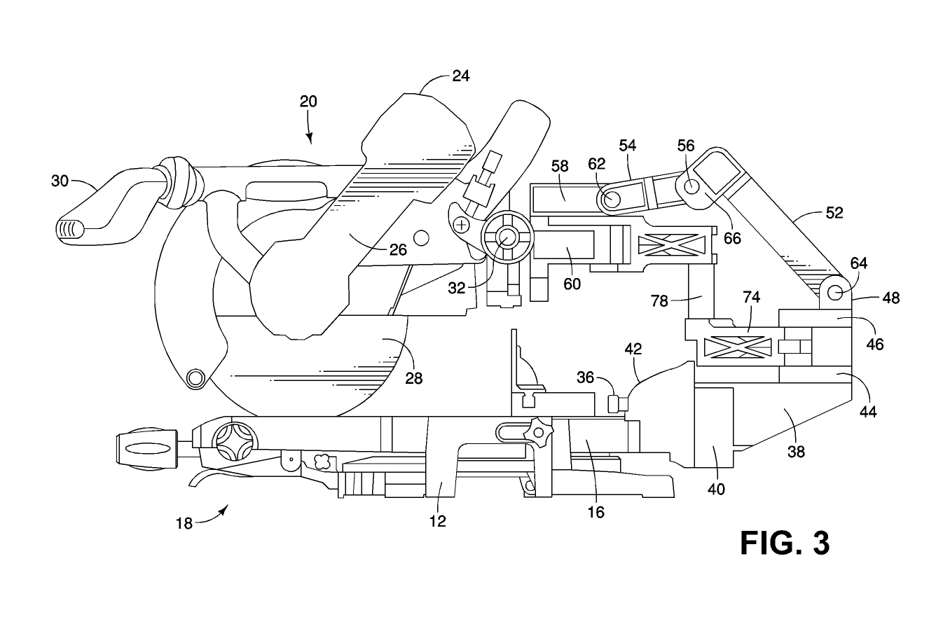

Turning now to the first preferred embodiment shown in FIGS. 1-4, the miter saw, indicated generally at 10, has a generally circular base 12 with an attached fence 14, which base supports a rotatable table 16 that has a miter arm control assembly, indicated generally at 18, for adjusting the rotational position of the table for setting the miter angle of work piece that would be placed on the table 16. A saw blade and motor assembly, indicated generally at 20, is operatively connected to the table 16 by a linear guide mechanism, indicated generally at 22. The saw blade and motor assembly 20 has an electric motor 24 that is operatively connected through a belt and gear mechanism, not shown but located within housing portion 26 that drives a saw blade 28. A handle 30 enables an operator to move the blade and motor assembly 20 into and out of engagement with a work piece that may be placed on the table 16 adjacent the fence 14. The blade and motor assembly 20 is pivotable about a saw pivot shaft 32 that is connected to a saw pivot head 34 to which the linear guide mechanism 22 is attached. The blade and motor assembly 20 is shown in FIG. 1 to be in a position where the blade is moved to its extended position away from the fence 14 and lowered into cutting position where a workpiece is placed on the table 16. During operation, an operator places a workpiece on the table 16, brings the handle 30 down into cutting position either before or after activating the motor 24 and then pushes the handle 30 toward the fence 14 to have the blade 28 cut the work piece. At the end of the cut, the blade and motor assembly 20 would be essentially in the position shown in FIG. 2 where the bottom reach of the blade 28 is generally coextensive with the fence 14.

The linear guide mechanism 22 of the first preferred embodiment shown in FIGS. 1-4 is designed so that the miter saw has a dual bevel operation, rather than a single bevel operation, meaning that the bevel angle can be adjusted either right or left from the normal zero angle or position wherein the plane of the blade 28 is perpendicular to the plane of the top surface of the table 16. The blade and motor assembly 20 as well as the linear guide mechanism and rotate about a bevel pivot shaft 36, with the linear guide mechanism having a support frame 38 with a generally cylindrical end portion 40 to which the bevel pivot shaft 36 is connected to. The shaft 36 extends through an opening in an enlarged extension 42 of the table 16. Thus, the end portion 40 can rotate relative to the extension 42 and be supported by the shaft 36. The support frame 38 is preferably a casting that has a lower flange 44, an upper flange 46 as well as vertically oriented flanges 48 and 50.

A horizontal hinge linkage is comprised of links 52 and 54 which have adjacent ends connected together by a shaft 56. The saw pivot head 34 has a pair of spaced flanges 58 as well as a single flange 60 located below the flanges 58. The link 54 has its opposite end connected to the flanges 58 by a shaft 62. Similarly, the opposite end of the link 52 is connected to the vertical flanges 48 and 50 by a shaft 64. As previously mentioned and while not specifically illustrated, the shafts 32, 62, 56, 64, 78 and 82 are preferably of the type which utilize rotary bushings or low cost ball bearings so that they are freely rotatable and will have an extended useful life.

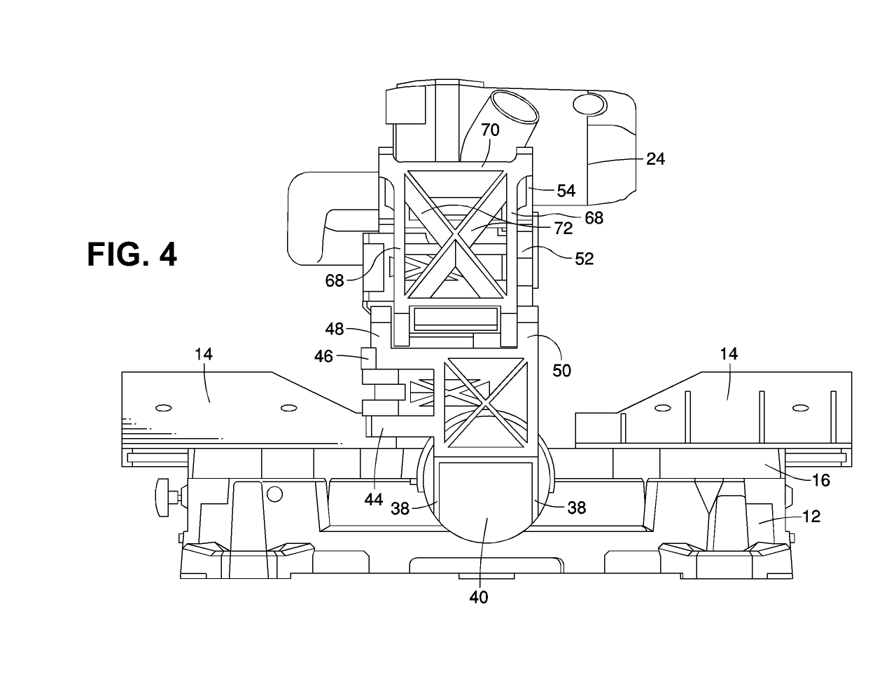

As is best shown in FIGS. 1 and 2, the link 52 has a generally L-shaped side configuration with the transverse extension 66 having the aperture in which the shaft 56 is located. This permits the two links 52 and 54 to be folded together in a generally parallel arrangement as shown in FIG. 2 when the blade and motor assembly 20 is moved into its final cutting position where the blade is adjacent to the fence 14. As is best shown in FIG. 4, the width of the links 52 and 54 is relatively large and therefore the shafts 56, 62 and 64 that interconnect the links 52 and 54 with one another and with the saw pivot head 34 and support frame 38 are relatively long. This contributes to the desirable stiffness of the linear guide mechanism which substantially reduces, if not eliminates, any movement by the blade out of the cutting plane which can result in poor quality cutting. Stated in other words, the extremely wide links and their coupling to the saw pivot head and support frame 38 results in high rigidity reducing torsional and linear deflection of the saw blade away from its intended cutting plane which is very desirable from a cut quality standpoint.

As best shown in FIG. 4, the link 52 is not a solid construction, but has side walls 68 and end walls 70 with cross braces 72 provided to provide increased overall strength for the link. The link 54 is similarly constructed as is shown in FIG. 1, it also having similarly configured side walls, end walls and cross braces. The hinge links 52 and 54 are preferably die cast aluminum but can be steel stamping if desired.

The vertical hinge linkage is located below the horizontal hinge linkage and it comprises links 74 and 76 which have adjacent ends connected together by a vertical shaft 78. The links 74 and 76 are not as wide as the horizontal hinge links 52 and 54 for the reason that their functionality is to maintain the elevation of the saw pivot head 34 constant during movement of the blade and motor assembly 20 toward and away from the fence 14. Elevational deflections are not as critical for a miter saw cut quality for the reason that the work piece is generally being completely cut through.

The narrower links 74 and 76 are vertically displaced from one another which requires the elongated vertical shaft 78 to extend to interconnect them. The link 74 is located between the horizontal flanges 44 and 46 and is pivotally connected to these flanges by a shaft 80. Similarly, the link 76 has spaced flange portions that are connected to the flange 60 by a shaft 82. As is shown in FIG. 1, the flange 60 is located beneath the near flange 58 and the flanges 44 and 46 are also located beneath the vertical flanges 48 and 50, and the shaft 78 that interconnects the links 74 and 76 extends away or to the left side of the saw (as viewed from the handle 30) so that when the vertical and horizontal linkages are folded together as shown in FIG. 2, little if any portion of the links extend outside of the width of the flanges 48 and 50. This is significant in that changing of the bevel angle of the blade and motor assembly 20 can be accomplished in either the left or the right direction and the hinge linkages will not interfere with the dual bevel adjusting capability.

It should also be apparent from FIG. 2 that when the blade and motor assembly 20 are moved as far toward the fence 14 as is possible, the linkages do not extend in any rearward direction beyond the original position end of the support frame 38. This enables the miter saw to be placed near a wall, for example, and be fully operational, unlike many conventional sliding rod and bushing configurations of compound miter saws.

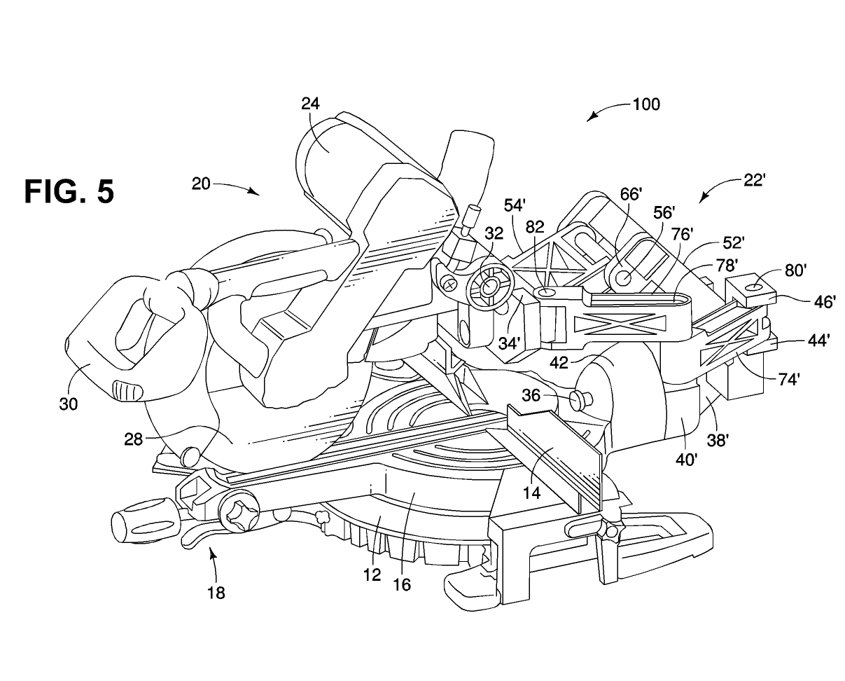

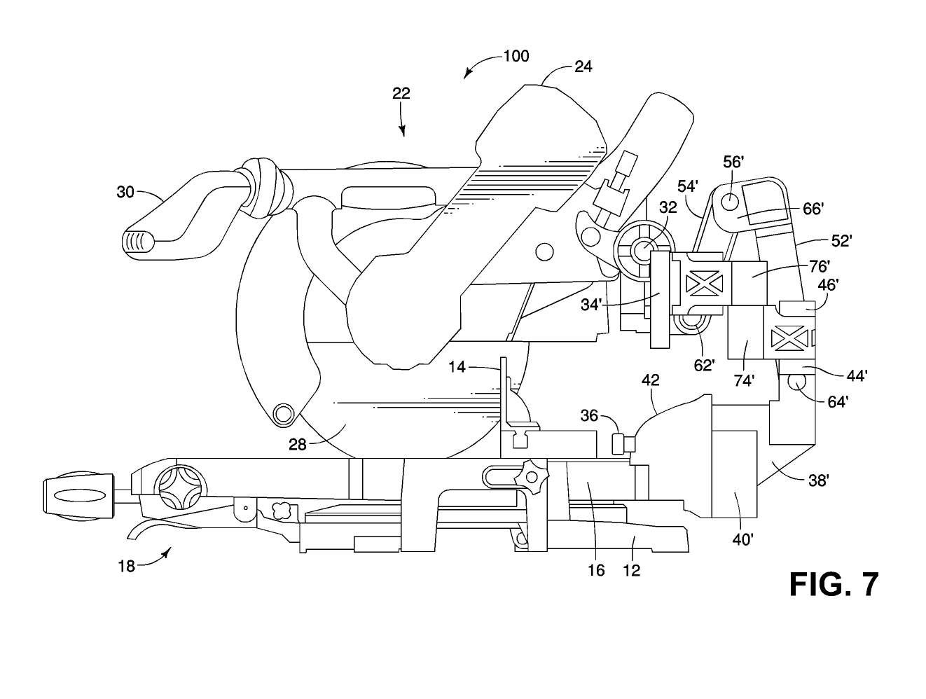

A second preferred embodiment is shown in FIGS. 5-8 and have many similar components as the embodiment shown in FIGS. 1-4. In the following description, components that are labeled with the same numbers as those shown and described with regard to the first preferred embodiment are substantially similar in their design, configuration and operation and therefore will not be described in detail. Components with reference numbers having a prime or double prime designation are similar to those that are identified with regard to the embodiment shown in FIGS. 1-4, but may have some structural differences which are apparent or which will be generally described or which will be given different numbers than those illustrated in FIGS. 1-4.

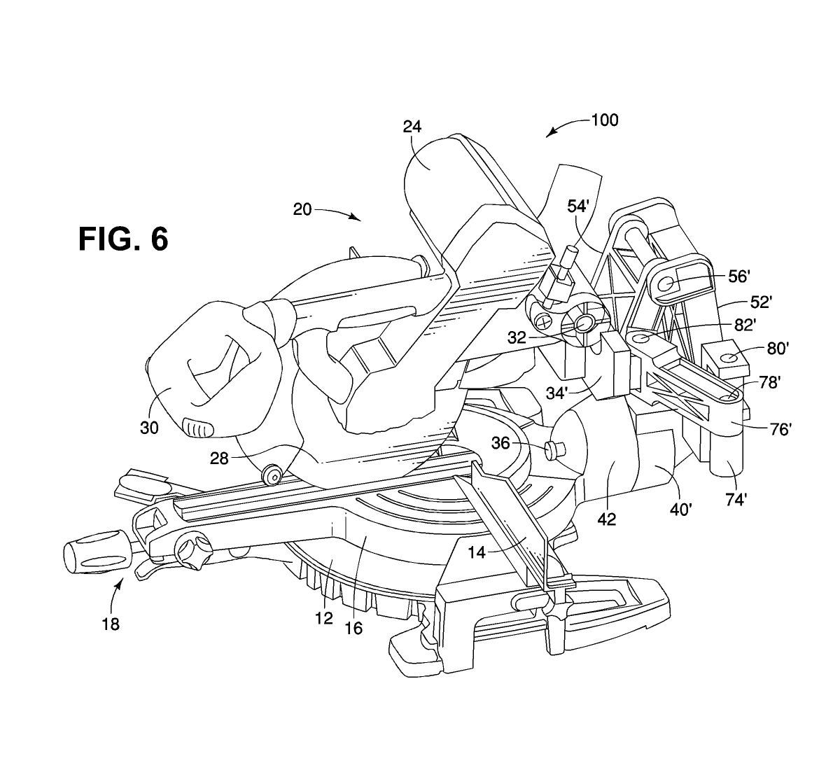

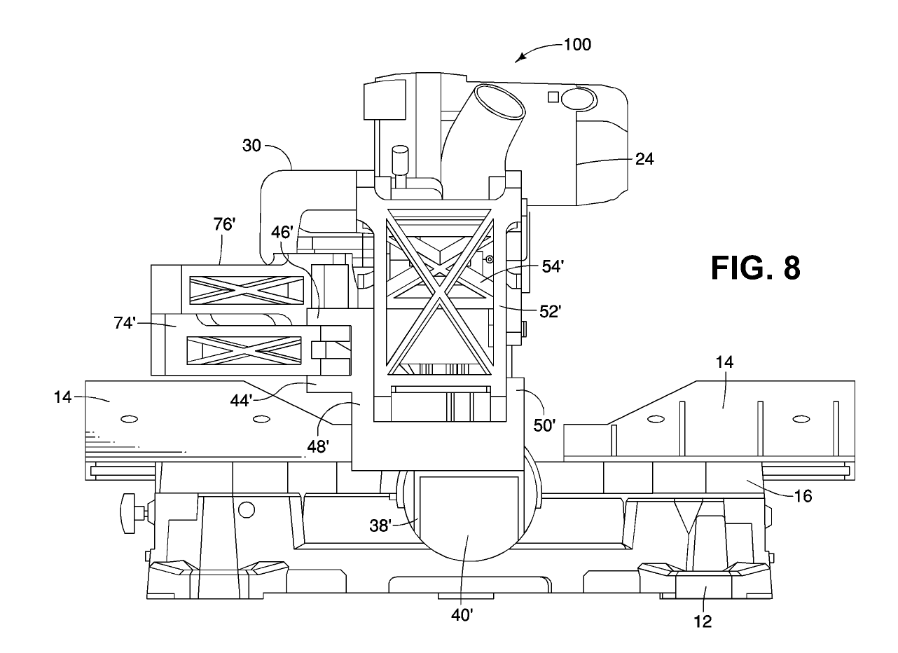

The second preferred embodiment is indicated generally at 100 in FIGS. 5-8 and has many similarities to the first preferred embodiment, but while the first embodiment is a dual bevel configuration saw, the second embodiment saw 100 is a single bevel configuration. The links 74′ and 76′ are connected together by a shaft 78′ that is not as long as the shaft 78 of the first preferred embodiment, because the links 74′ and 76′ are vertically adjacent one another rather than being spaced apart. Also, the link 76′ is at an elevation that is substantially similar to the elevation of the link 54′ and therefore unable to fold toward the link 52″ and 54′. Thus, the connection between link 74′ and 76′ extends outwardly away from the links 52′ and 54′. Because of the outward extension, particularly when it is folded as shown in FIGS. 6 and 8, the links interfere with other portions of the saw 100 when the saw would be pivoted in the counterclockwise direction as shown in FIG. 8. Therefore, the single bevel operation of this second preferred embodiment is in the clockwise direction as shown in FIG. 8.

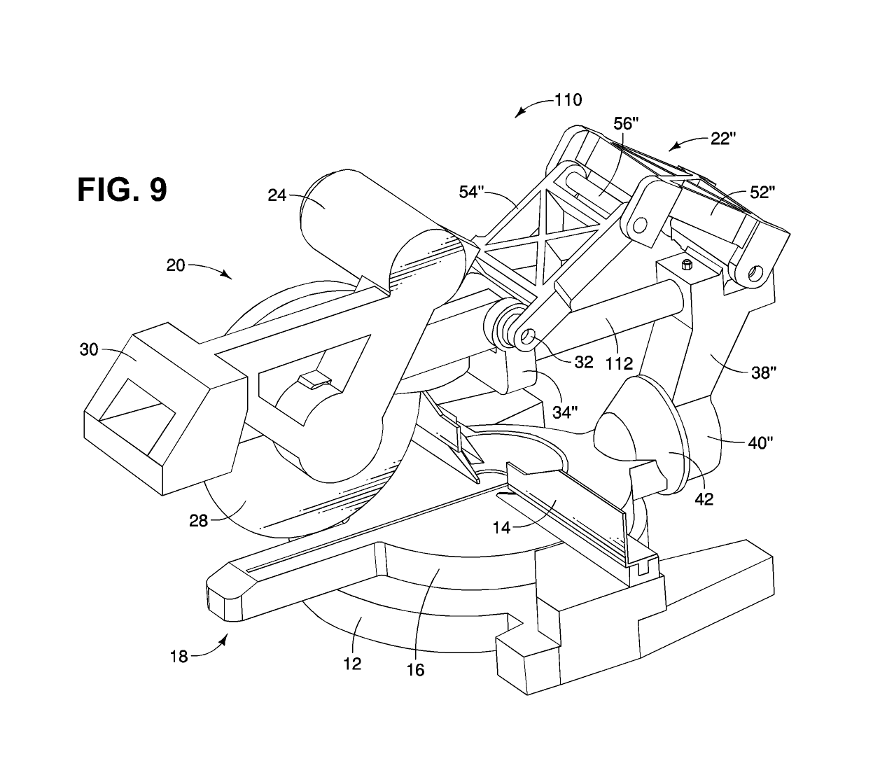

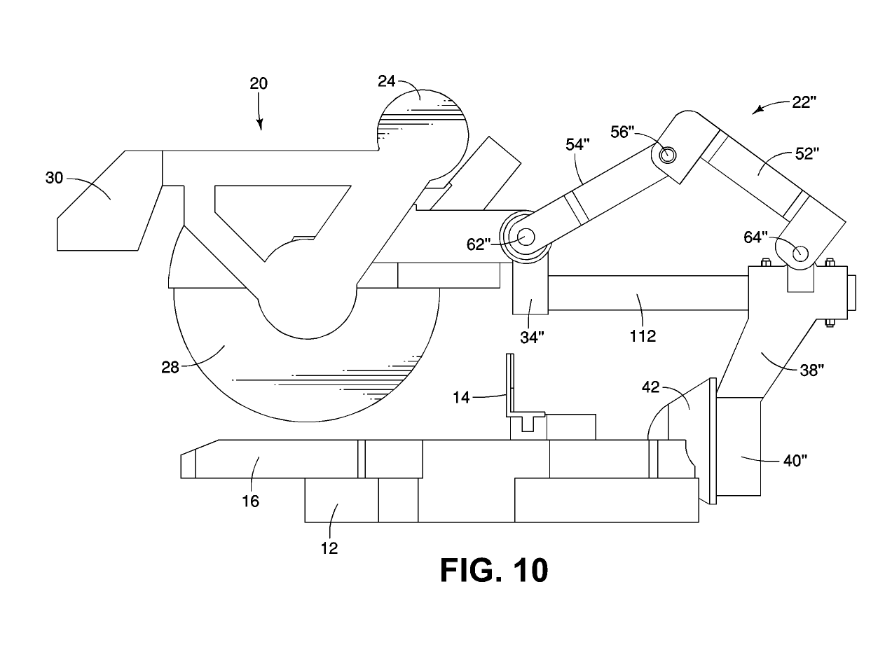

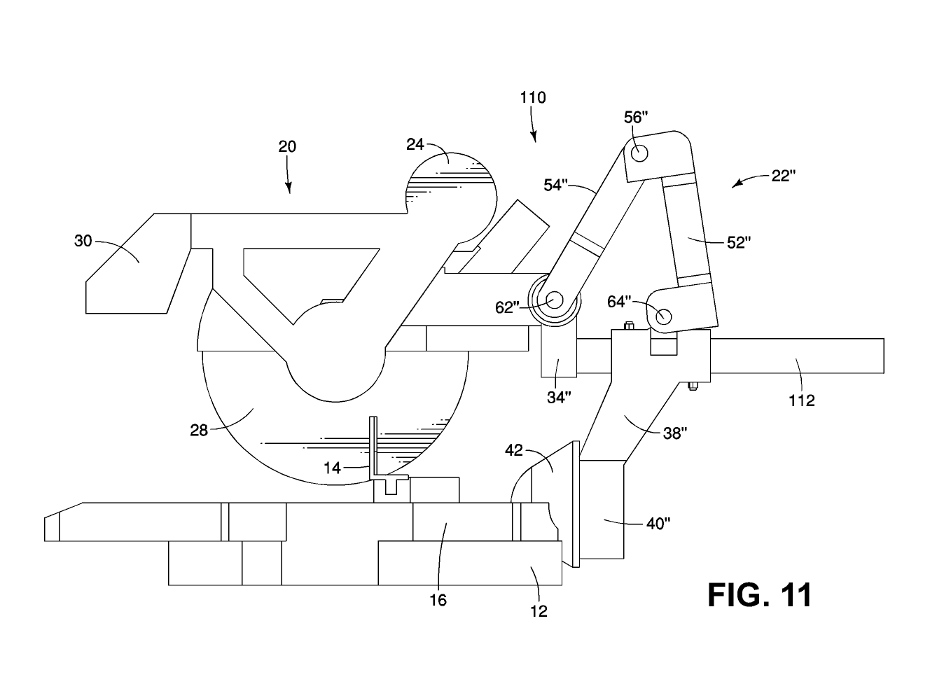

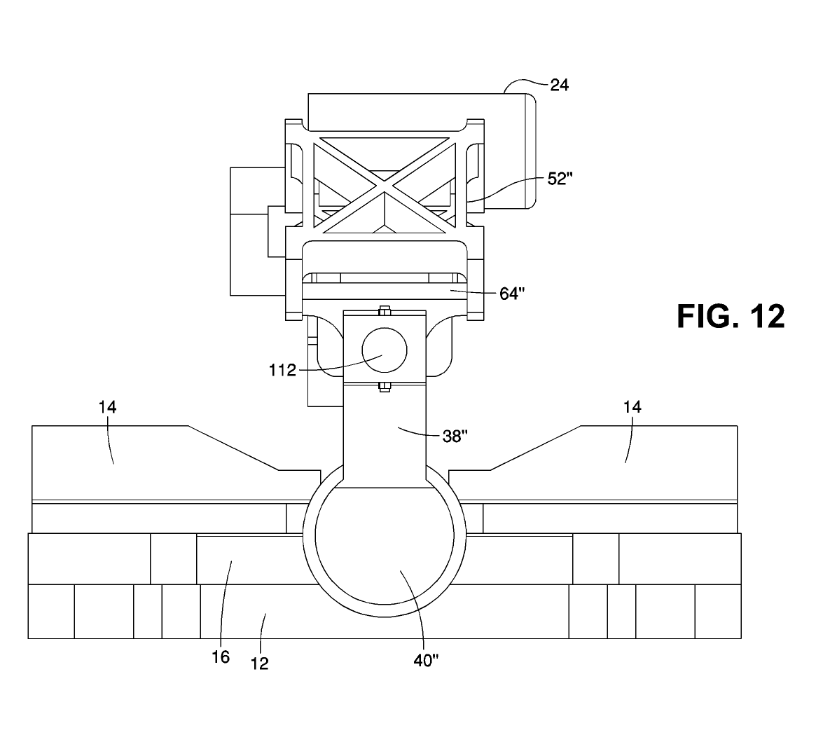

A third preferred embodiment of the invention is the saw 110 that is shown in FIGS. 9-12 is less detail than the embodiments of FIGS. 1-8. Saw 110 has a horizontal hinge linkage comprising links 52″ and 54″ that are interconnected and operate substantially similar to those described in the embodiments of FIGS. 1-8. The saw pivot head 34″ has a slightly different configuration and the end of the link 54″ is connected to the saw pivot shaft 32 which is also journaled in the saw pivot head 34″. An elongated rod 112 is journaled in a bushing (not shown but located in the upper end of support frame 38) and maintains the saw pivot head 34″ at a constant elevation as the blade and motor assembly 22 moves the blade 28 toward the fence 14. Only one rod 112 is provided for the reason that control of the saw blade cutting plane is provided by the horizontal hinge linkage, as is the case with the other embodiments shown in FIGS. 1-8, and the only function that is performed by the rod 112 is to keep the pivot head 34″ at a constant elevation during operation. In this regard, the blade and motor assembly 20 is shown in its retracted position in FIGS. 9 and 10 and in the cutting position in FIG. 11 where the blade 28 is adjacent the fence 14. In the position shown in FIG. 11, it is apparent that the rod 112 will extend beyond the rear surface of the support frame 38″ which requires a larger footprint in that it would not be possible to place the saw 110 with the support frame 38″ located close to a wall or other similar surface. Thus, while this embodiment does not have the space advantages of the first and second preferred embodiments, this embodiment has the advantage of controlling the saw blade cutting plane by a generally horizontal hinge as is achieved in all embodiments and only one rod and bushing combination is required which provides a cost benefit compared to conventional arrangements which have a pair of rod and bushing configurations.

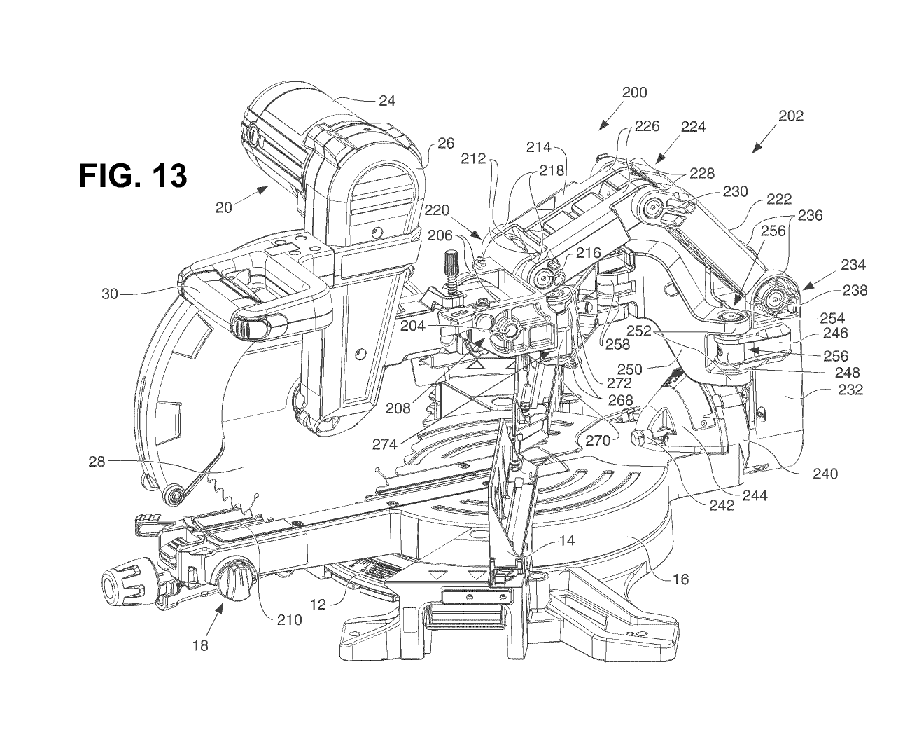

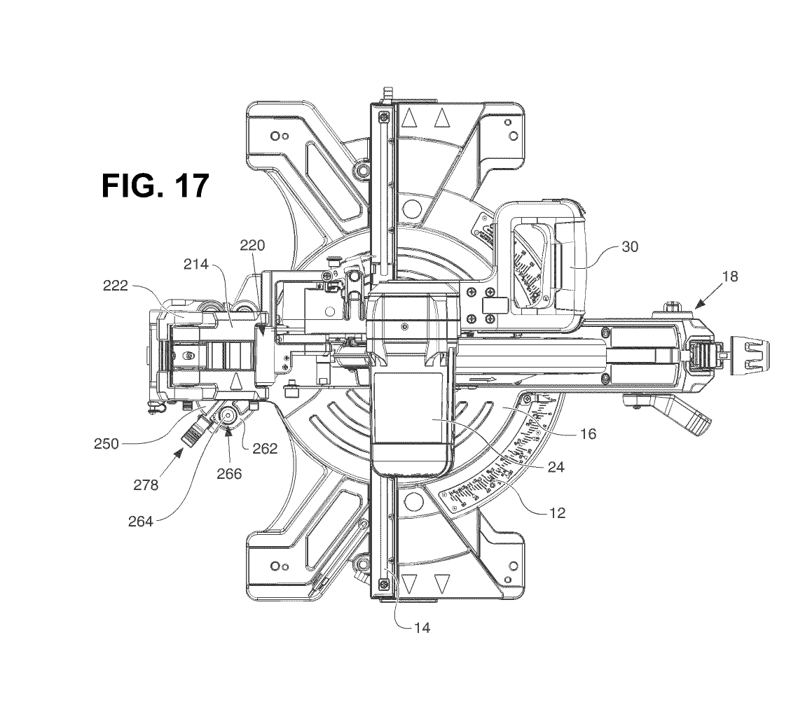

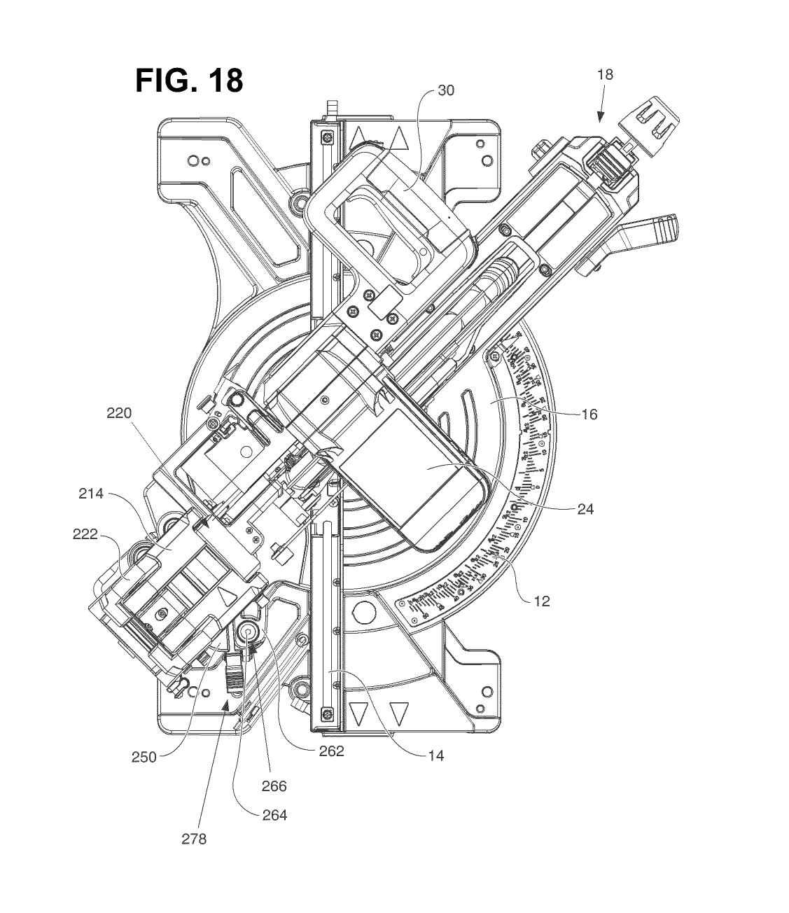

In accordance with another described embodiment of the invention, a miter saw is shown in FIGS. 13-19 and is indicated generally at 200. This embodiment is also described in related U.S. Application Ser. No. ______ (GBC Docket No. 0212.072978C1), which is hereby incorporated by reference it its entirety. Many of the components are similar to the first embodiment 10 so that where reference numbers are the same as the description of the FIG. 1, such components and their functionality are very similar, if not identical. Components with reference numbers above 200 are sufficiently different from analogous components of the other embodiments to warrant separate numbers or are new in the fourth embodiment.

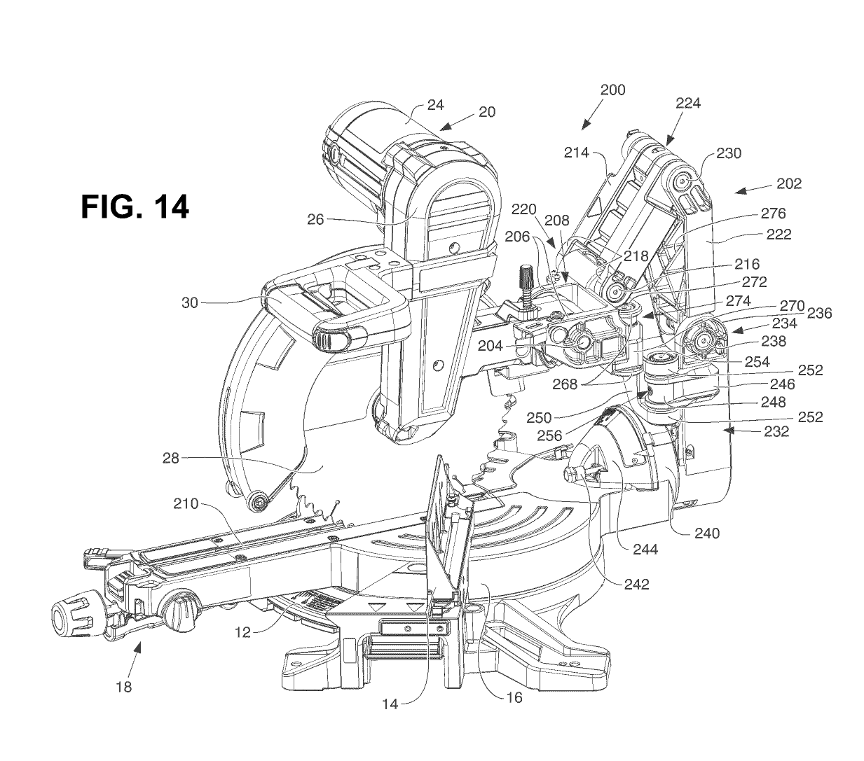

Turning to FIGS. 13 and 14, the miter saw 200 also has a generally circular base 12 with an attached fence 14. The base 12 supports a rotatable table 16 that has a miter arm control assembly, indicated generally at 18, for adjusting the rotational position of the table for setting the miter angle of a workpiece that would be placed on the table. A saw blade and motor assembly, indicated generally at 20, is operatively connected to the table 16 by a linear guide mechanism, indicated generally at 202. The saw blade and motor assembly 20 has an electric motor 24 that is operably connected through a belt and gear mechanism(not shown), but located within the housing portion 26 that drives a saw blade 28. A handle 30 enables the operator to move the blade and motor assembly 20 into and out of engagement with a workpiece (not shown) that is placed on the table 16 adjacent the fence 14.

The blade and motor assembly 20 is pivotable about a saw pivot connection shaft 204 extending between a pair of spaced outer flanges 206 on a pivot head 208. When the handle 30 is lowered by an operator, the blade 28 will be lowered into its cutting position and slightly penetrates a slot 210 formed in the table 16. The pivot head 208 also has a pair of spaced inner flanges 212 (best shown in FIG. 13) that extend in the opposite direction from the outer flanges 206 that are connected to the blade and motor assembly 20, and offset from the center of the pivot head 208, opposite one of the outer flanges 206. The inner flanges 212 are provided between a pair of spaced outer flanges 218 extending from one end of a first horizontal link 214. A pivot connection shaft 216 extends horizontally through holes in the inner and outer flanges 212 and 218 to pivotally connect the inner and the outer flanges 212, 218. Together the inner flanges 212 of the pivot head 208, the pivot connection shaft 216 and the outer flanges 218 of the first horizontal link 214 form a horizontal hinge connection 220.

At the opposite end from the horizontal hinge connection 220, the first horizontal link 214 is connected to a slightly longer second horizontal link 222 by another horizontal hinge connection 224. It should be understood, however, that the miter saw 200 may include one or more additional horizontal links that may be connected to the first and second links 214, 222 without departing from the scope of the patent. Included in the hinge connection 224 is a pair of spaced inner flanges 226 that extend from the end of the first horizontal link 214 opposite the end having outer flanges 218. The inner flanges 226 are provided between and pivotally connected to a pair of spaced outer flanges 228 extending from the upper end portion of the second horizontal link 222, by a pivot connection shaft 230.

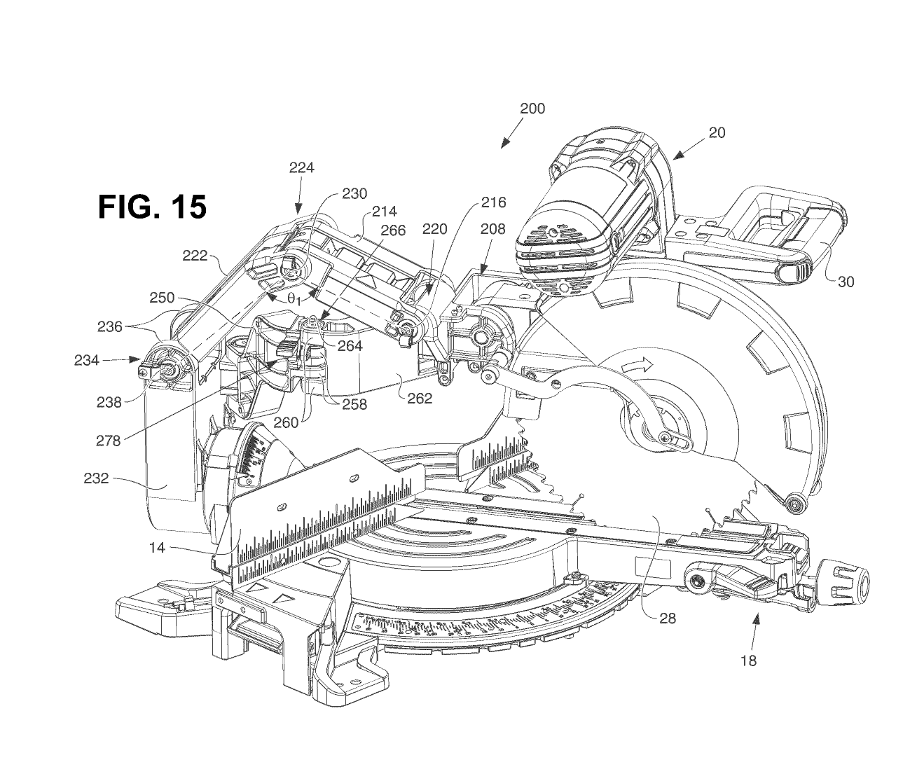

The second horizontal link 222 has its lower end portion connected to a vertical support 232 by a horizontal hinge connection 234. The hinge connection 234 includes a pair of spaced outer flanges 236 (best shown in FIG. 15) extending from the top of the vertical support 232 and a pair of inner flanges (not shown) extending from the lower end of the horizontal link 222 and provided between the outer flanges of the vertical support. A pivot connection shaft 238 extends through the outer flanges 236 of the vertical support 232 and the inner flanges of the second horizontal link 222 for a pivotal connection. The outer flanges 228 of the second horizontal link 222 in the hinge connection 224 extends at an angle of approximately 30 degrees from the generally linear longitudinal portion of the second horizontal link to enable the first horizontal link 214 to be folded close to the second horizontal link, as shown in FIG. 14. It is to be understood that the angle other than the described above may be utilized as well.

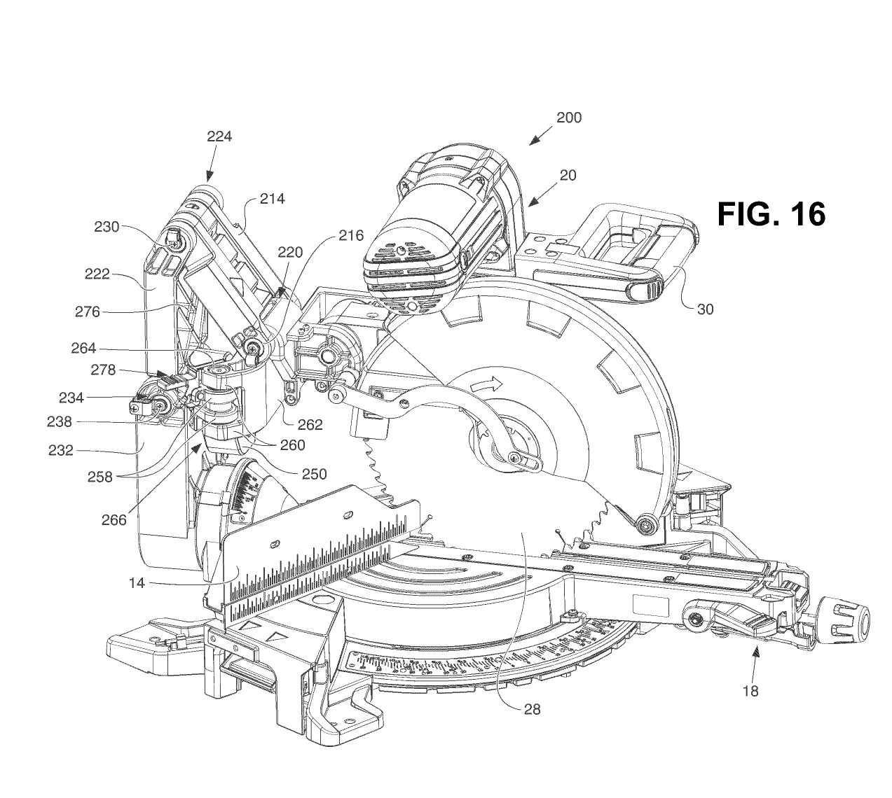

As is best shown in FIGS. 14 and 16, when the blade and motor assembly 20 is in its retracted position, the second horizontal link 222 is in a generally vertical orientation. It should be appreciated that the horizontal pivot connection shafts 216, 230, 238, and the corresponding hinge connections 220, 224, 234, are oriented parallel to one another and substantially perpendicular to the plane of the blade 28. The first and second horizontal links 214, 222 are relatively wide, approximately 80 to 160 millimeters and the thickness of them is substantial, approximately 10 to 80 millimeters so that they resist bending which would detrimentally affect the quality of the cut by the blade 28. The length of the first horizontal link 214 is approximately ¾ of the length of the second horizontal link 222. In one embodiment, the length of the first horizontal link 214 is approximately 120 to 220 millimeters and that of the second horizontal link 222 is approximately 200 to 300 millimeters so that the point of the blade 28 that make contact with the workpiece is at a sufficient distance from the fence 14 to cut the intended workpiece, but before the contact point reaches the end of the slot 210 provided in the table 210. Of course, it should be understood that the width, the thickness, and the length of the first and second links 214, 222 other than those described above may be utilized as well.

The vertical support 232 is integrally formed with a support frame 240 that is generally cylindrically shaped. Of course, the support frame 240 may take the form of various shapes and have a number different sizes. A bevel pivot shaft 242 supported by an extension 244 of the table 16 enables the support frame 240 and the vertical support 232 to pivot either to the left or right of the plane of the blade 28 for the purpose of providing bevel cuts. The vertical support 232 also has a side mounting structure 246 with a pivot block 248 for pivotally supporting an angled first vertical link 250, which has a pair of outer flanges 252 at one end. The pivot block 248 is provided between and connected to the two outer flanges 252 of the first vertical link 250 by a vertical pivot connection shaft 254 that extends through the holes formed in the outer flanges and the pivot block. The outer flanges 252, the pivot block 248 and the pivot connection shaft 254 combine to form a vertical hinge connection 256. It should be noted that the pivot block 248 can be an integral part of the vertical support 232, or it can be a separate component that is affixed to the vertical support 232.

Referring to FIGS. 13, 15 and 16, the first vertical link 250 has a pair of spaced inner flanges 258 extending from the end opposite the end having the outer flanges 252. The inner flanges 258 are provided between a pair of spaced outer flanges 260 extending from a second vertical link 262. A vertical pivot connection shaft 264 extends through the aligned holes in the inner and outer flanges 258, 260 to pivotally connect the first and second vertical links 250, 260 together and form a vertical hinge connection 266. While the inner flanges 258 are described as being “spaced,” it should be understood that they are not necessarily separated. They can also be integrally connected by a somewhat narrower piece provided between the flanges 258. Alternatively, the inner flanges 258 can also be replaced with one cylindrical piece protruding from the end of the link 250.

As best shown in FIG. 15, the outer and the inner flanges 260, 258 of the second vertical link 262 and the first vertical link 250 extend at a slight angle from the linear portion of each of the first and second vertical links 250,262 to enable the first and second vertical links 250, 262 to be folded close to each other, as shown in FIG. 16. Preferably, the flanges 258, 260 should extend at an angle of approximately 30 to 120 degrees relative to the linear portion of the respective first and second vertical links. It is to be understood that the angle other than the described above may be utilized as well.

At the opposite end from the outer flanges 260, a pair of spaced outer flanges 268 extend from the second vertical link 262 and are pivotally connected to a pivot block 270 provided between the two outer flanges by a vertically oriented pivot connection shaft 272 (best shown in FIGS. 13 and 14), thereby forming another vertical hinge connection 274. The pivot block 270 is attached to the pivot head 208 on the opposite side from the outer flanges 206 and adjacent the inner flanges 212 of the pivot head.

As with the embodiment shown in FIG. 13, the vertical pivot connection shafts 254, 264, 272 maintain the elevation of the pivot head 206 substantially constant relative to the table 16. The length of the first vertical link 250 is approximately the same as the length of the second vertical link 262, and each of the first and second vertical links 250, 262 are approximately 7/10 of the length of the second horizontal link 222. In one embodiment, the length of the first vertical link 250 is approximately 120 to 220 millimeters and that of the second vertical link 262 is also approximately 120 to 220 millimeters. The width and thickness of the first and second vertical links 250, 262 are comparable to the first and second horizontal links 214, 222. However, the amount of possible bending of the vertical links 250, 262 is not as critical as bending that could occur with the horizontal links 214, 222 inasmuch as the quality of a cut is generally not affected by vertical movement of the blade during extension and retraction because the blade penetrates the slot 210 during most cutting operations. Of course, it is to be understood that the width, the thickness, and the length of the first and second links 214, 222 other than those described above may be utilized as well. As is evident from the drawings, the horizontal and vertical links 214, 222, 250, 262 are not solid but may be constructed from cast of aluminum and have reinforcing ribs 276 (best shown in FIG. 14) that extend across the interior of the links to impart additional strength. In some embodiments, the horizontal and vertical links 214, 222, 250, 262 may be constructed from steel stamping, sheet metal, or any high strength plastic.

Additional structural strength is provided with the fourth embodiment for the reason that all the horizontal and the vertical hinge connections 220 224, 234, 256, 266, 274 have outer flanges that fit outside a pair of inner flanges or pivot blocks, which support each the horizontal and vertical links 214, 222, 250, 262 at both ends rather than an overhung load connection. The double-ended support provides a stronger connection that imparts an increased strength to the links. The horizontal and vertical pivot connection shafts 216, 230, 238, 254, 264, 272 are, therefore, also supported at opposite ends, which is a stronger connection.

In the described fourth embodiment, the vertical hinge connection 256 at the lower end of the first vertical link 250 is provided at the top portion of the vertical support 232 (not including the outer flanges 236) and is slightly below the vertical hinge connection 266 at the other end of the vertical link 250 (best shown in FIG. 14). Accordingly, the vertical link 250 extends at an angle between the vertical hinge connections 256 and 266. It should be understood, however, that the length of the vertical support 232 may be increased so that the location of the pivot block 248, and accordingly, the vertical hinge connection 256, may be at the same height as the vertical hinge connection 266. In other words, the first vertical link 250 may extend substantially parallel to the table top 16 as is the second vertical link 262. However, with this arrangement, there may be an issue of the miter saw 200 being undesirably top heavy.

Another consideration is that the angle between the first and second horizontal links 214, 222 as determined by the line of action between a line extending through pivot connection shafts 230 and 216 in the horizontal hinge connections 224 and 220 relative to the line of action through pivot connection shafts 230 and 238 in the horizontal hinge connections 224 and 234, identified as angle θ₁ in FIG. 15 should be less than 130° when the saw is fully extended to prevent a toggle action of the links. While not shown, the angle between the first and second vertical links 250 and 262 as determined by the line of action between a line extending through vertically oriented pivot connection shafts 264 and 254 in the vertical hinge connections 266 and 256 relative to the line of action through vertical pivot connection shafts 264 and 272 in the vertical hinge connections 266 and 274, also should be less than 130° when the saw is fully extended to prevent a toggle action of the links. The toggle action is defined herein to mean an increased necessary force to push the blade and motor assembly 20 from its extended position, shown in FIGS. 13 and 15 toward the retracted position shown in FIGS. 14 and 16. If a toggle action is experienced, a greater noticeable and appreciable force is required to start the movement. If the angles of the links are less than 130°, such toggle action is not experienced.

During operation, an operator places a workpiece on the table 16, brings the handle 30 down into cutting position either before or after activating the motor 24, as shown in FIGS. 13 and 15, and then pushes the handle 30 toward the fence 14 to have the blade 28 cut the workpiece. At the end of the cut, the blade and motor assembly 20 would be essentially in the position shown in FIGS. 14 and 16, where the bottom reach of the blade 28 is generally coextensive with the fence 14.

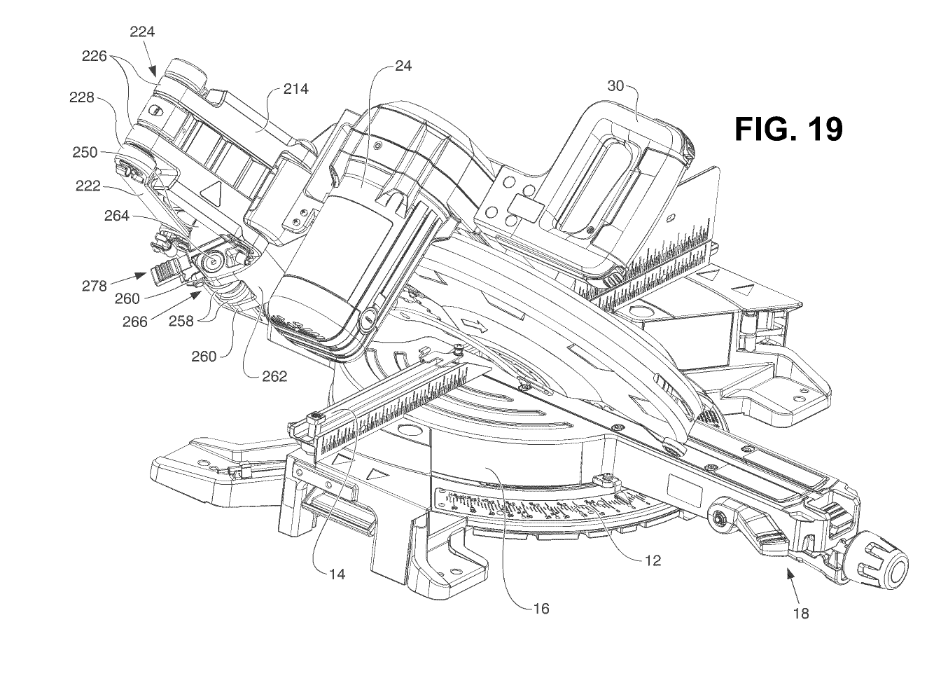

As is shown in FIGS. 15 and 16, the first and second vertical links 250, 262 are located beneath the first and second horizontal links 214, 222 and the vertical connection hinge 266 that interconnects the vertical links extends away or to the left side of the saw (as viewed from the handle 30). In this manner, when the saw 200 is in a retracted position and the vertical and horizontal links 214, 222, 250, 262 are folded together, as shown in FIGS. 16-19 only a small portion (e.g., approximately 20 to 100 millimeters) of the vertical links 250, 262 extend outside of the width of the horizontal links 214, 222. This is significant in that changing of the bevel angle of the blade and motor assembly 20 can be accomplished in either the left or right direction and the vertical links 250, 262 will not interfere with the dual bevel adjusting capability, as illustrated in FIG. 19.

Another desirable attribute of this described embodiment is particularly illustrated in FIGS. 14, 16 and 17 wherein the blade and motor assembly 20 is in its retracted position and the second horizontal link 214 is substantially vertical. Since the link 214 does not extend rearwardly beyond the vertical support 232, it can be appreciated that the saw 200 can be placed very close to a rear wall or the like without impairing the normal operation of the saw.

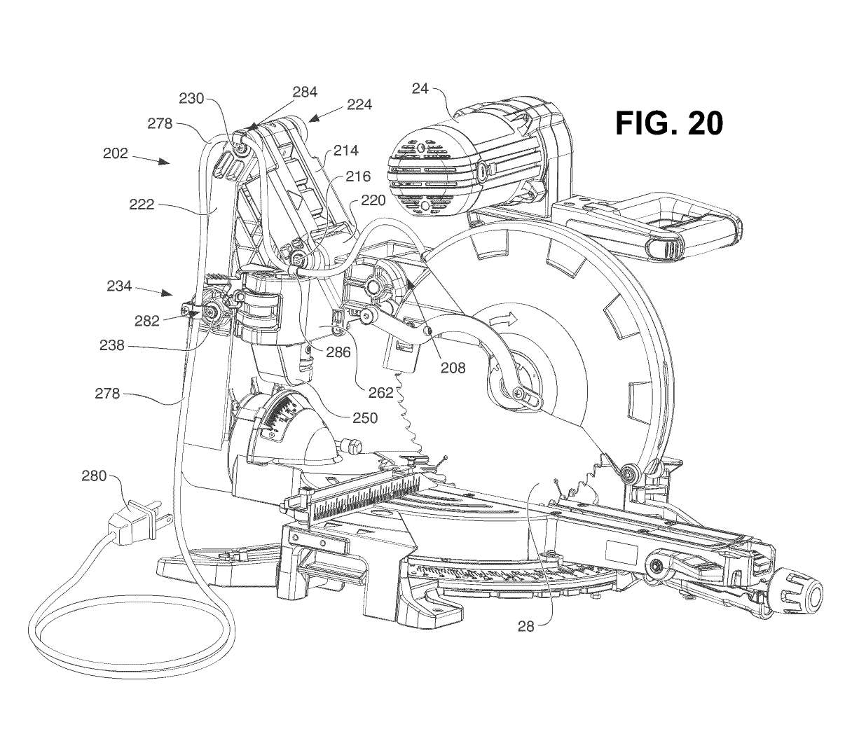

Referring now to FIGS. 20-24, and in accordance with another aspect of the patent, the manner in which the electric motor 24 of the blade and motor assembly 20 receives its power is described. While applicable to all of the above-described embodiments, the system for supplying power to the motor 24 of a miter saw having hinged linear guide mechanism is described specifically with respect to the embodiment as an exemplary example. It should be understood, however, that the power supply system can be implemented in the other three embodiments as well.

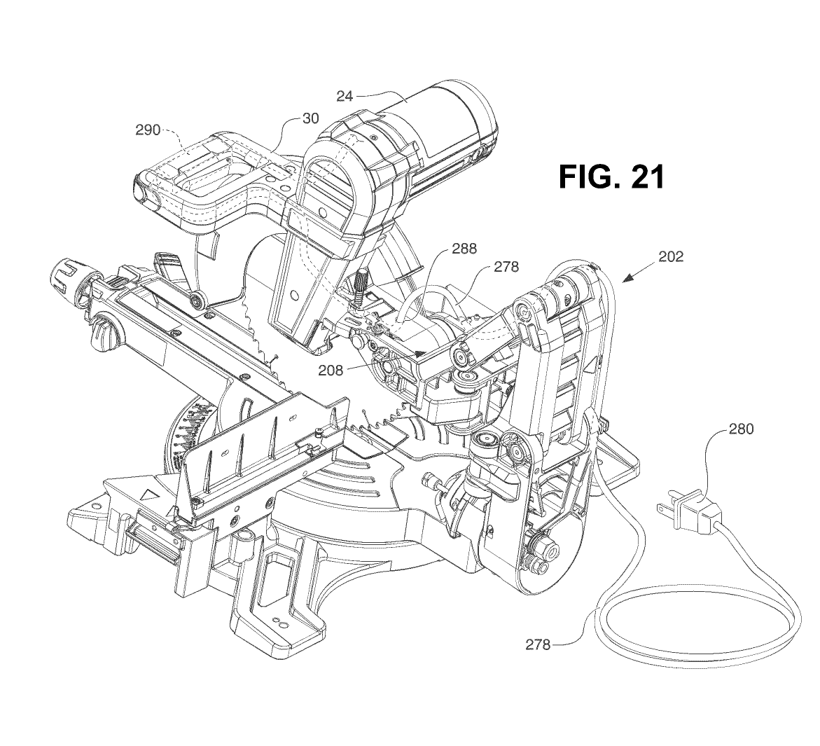

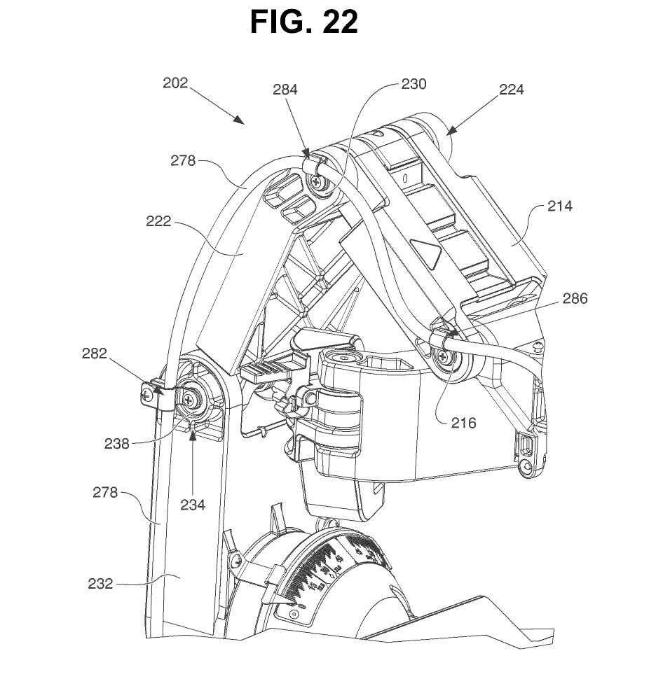

As shown in FIGS. 20 and 22, the motor 24 receives its power through a power cord 278 which has a plug 280 adapted to be connected to an appropriate power source such as a 120V AC outlet (not shown), for example, and be of suitable gage to carry the current required by the motor. At a desired distance away from the plug 280, the cord 278 is routed through a first cord clip 282 which is rotatably fixed to the horizontal pivot connection shaft 238 in the horizontal hinge connection 234 that connects the vertical 232 and the second horizontal link 222. The cord 278 is then routed through a second cord clip 284 which is rotatably fixed to the horizontal pivot connection shaft 230 in the horizontal hinge connection 224 that connects the second horizontal link 222 and the first horizontal link 214. Thereafter, the cord 278 is routed through a third cord clip 286 which is rotatably fixed to the horizontal pivot connection shaft 216 in the horizontal hinge connection 220 that connects the first horizontal link 214 and the pivot head 208. From the third clip 286 the cord 278 is routed into a hole 288 provided in the pivot head 208, as best shown in FIG. 21. As shown in phantom, after the cord 278 enters the hole 288 it is routed in any appropriate manner to a main switch 290 in the handle 30 and then to the motor 24.

While FIGS. 20-22 show the power cord 278 being routed through the cord clips 282, 284, 286 that are fixed to the left side (when seen from the front) of the linear guide mechanism 202, it should be understood that the cord clips can be also be provided on right side of the linear guide mechanism. In other words, the cord clips 282, 284, 286 would be rotatably fixed to corresponding horizontal pivot connection shafts 238, 230, 216 on the right side of the corresponding horizontal hinge connections 234, 224, 220. The power cord 278 would then be routed through the cord clips and into the hole 288 (best shown in FIG. 21) in the pivot head 208. The cord would then be routed as shown in FIG. 21 to the switch 290 in the handle 30 and then to the motor 24. In an alternate embodiment, the cord clips 282, 284, 286 would be rotatably fixed to either the top or bottom side of the corresponding horizontal hinge connections 234, 224, 220. The power cord 278 would then be routed through the cord clips 282, 284, 286 and into the hole 288 (best shown in FIG. 21) in the pivot head 208.

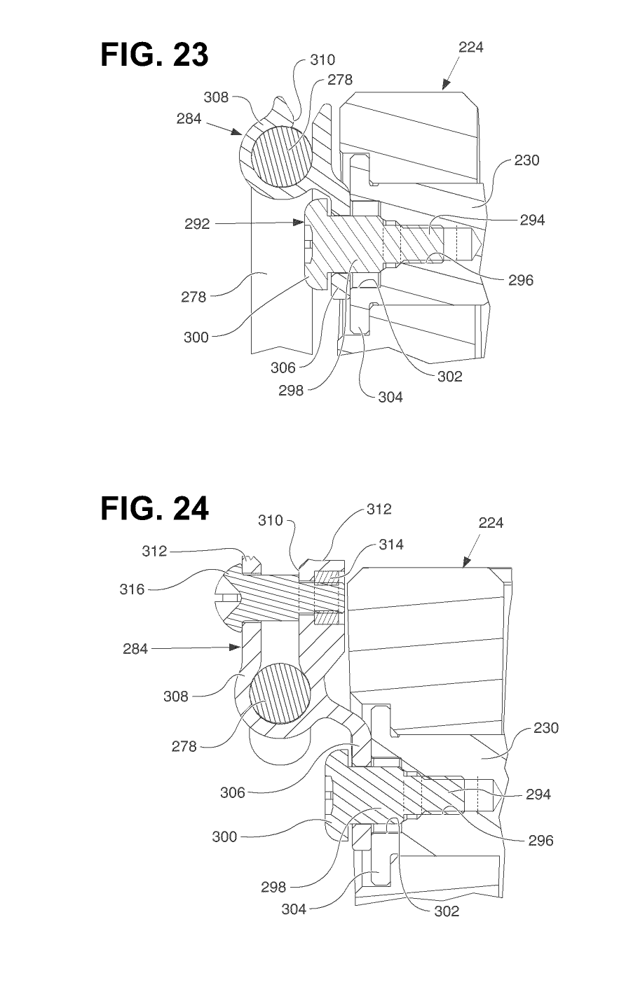

Turning now to FIG. 23, the cord clips 282, 284, 286 are fixedly coupled to their respective horizontal pivot connection shafts 238, 230, 216 by a screw 292 (the cord clip 284 and the pivot connection shaft 230 are shown in FIG. 23 as an example). The screw 292 has a threaded portion 294 which is configured to be thread into a threaded bore 296 formed in the longitudinal direction of the pivot connection shaft 230. The threaded portion 294 transitions to a shoulder portion 298 having a greater diameter than the threaded portion, and a head 300 having a greater diameter than the shoulder is formed at the opposite end of the shoulder from the threaded portion.

The shoulder 298 is configured to be coaxial with and provided partially in a countersink portion 302 formed in a head 304 of the pivot connection shaft 230. The diameter of the shoulder 298 is such that it prevents the head 300 of the screw 292 from being tightened against the head 304 of the pivot connection shaft 230 and leave a space between facing surfaces of the heads 300 and 304 of the screw and the pivot connection. This arrangement allows a mounting portion 306 of the clip 284 to be pinned in the space created between facing surfaces of the heads 300 and 304, and yet allow the clip to freely rotate about the shoulder 298 of the screw 292.

In the embodiment shown in FIG. 23, the cord clip 284 includes a sleeve 308 extending from the mounting portion 306 and having an opening 310 in the longitudinal direction. The diameter of the sleeve 308 is similar to that of the power cord 278 so that a section of the cord can be held in the sleeve. In the normal state, the opening 310 is smaller than the diameter of the cord 278. This secures the cord 278 in the sleeve 308. The cord clip 284 is made of a flexible material such as plastic or thin metal which allows the cord 278 to be inserted into and removed from the sleeve by exerting force sufficient to momentarily widen the opening 310. In other words, the power cord 278 can be snapped into and out of the sleeve 308 though the opening 310.

In another embodiment shown in FIG. 24, the sleeve 308 of the cord clip 284 includes a pair of spaced tabs 312 which extend generally parallel to each other and define the opening 310 at the ends. One of the tabs 312 has a threaded nut 314 embedded therein for receiving a threaded portion of a clamping screw 316 extending through a hole in the other tab. The clamping screw 316 and the nut 314 enables the cord 278 to be more securely held in the sleeve and prevent the cord from snapping out of the sleeve unintentionally.

Because the blade and motor assembly 20 of the patent is intended to be extended and retracted during the normal course of use, the horizontal and the vertical links 214, 222 and 250, 262 of the linear guide mechanisms 202 are subject to constant folding and unfolding relative to each other. These movements may cause the power cord 278 to be pinched by, or rubbed and wear against, the horizontal and vertical links 214, 222, 250, 262. If left loose, the power cord 278 may even get cut by the blade 28 or block the user's view of the work area, which could compromise the safety of the user. This patent provides an effective solution for routing the power cord 278 in a power miter saw 200 having a linear guide mechanism 202 with hinged links.

While various embodiments of the invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the following claims.

What is claimed is:

1. A power saw comprising:
a table configured to receive a workpiece;
a saw blade and motor assembly including a motor for rotating a saw blade;
a power cord connected to said motor for supplying electric power to said motor;
a linear guide mechanism operatively connected to said table and being configured to pivotally support said saw blade and motor assembly, said linear guide mechanism enabling movement of said saw blade and motor assembly along a predetermined linear path in a forward or a rearward direction;
said linear guide mechanism including at least two links connected by a first hinge connection; and
a first cord clip rotatably fixed to said hinge connection and configured to receive a first section of said power cord.

2. The power saw as defined in claim 1, wherein said linear guide mechanism is pivotally connected to said saw blade and motor assembly by a second hinge connection, and a second cord clip is rotatably fixed to said second hinge connection, said second cord clip being configured to receive a second section of said power cord.

3. The power saw as defined in claim 2, wherein said first and said second cord clips are provided on one end of said first and said second hinge connections on the same side of said linear guide mechanism.

4. The power saw as defined in claim 1, wherein said linear guide mechanism is operatively connected to said table by a second hinge connection, and a second cord clip is rotatably fixed to said second hinge connection, said second cord clip being configured to receive a second section of said power cord.

5. The power saw as defined in claim 4, wherein said first and said second cord clips are provided on one end of said first and said second hinge connections on the same side of said linear guide mechanism.

6. The power saw as defined in claim 1, wherein one end of said linear guide mechanism is pivotally connected to said saw blade and motor assembly by a second hinge connection,
an opposite end of said linear guide mechanism is operatively connected to said table by a third hinge connection,
a second cord clip is rotatably fixed to said second hinge connection, and
a third cord clip is rotatably fixed to said third hinge connection,
wherein said second and said third cord clips are configured to receive a second section of said power cord.

7. The power saw as defined in claim 6, wherein said first, said second and said third cord clips are provided on one end of said first, said second and said third hinge connections on the same side of said linear guide mechanism.

8. The power saw as defined in claim 1, wherein said first hinge connection includes a connection shaft for pivotally connecting said two links, and said first cord clip includes a mounting portion which is configured to be rotatably secured to an end of said shaft.

9. The power saw as defined in claim 8, wherein said connection shaft includes a threaded bore formed on a head thereof, and said mounting portion is rotatably secured to said connection shaft by a screw which has a threaded end portion configured to be threaded into said threaded bore.

10. The power saw as defined in claim 9, wherein said screw includes a non-threaded shoulder portion extending from said threaded end portion and configured to create a space between said head of said connection shaft and a head of said screw, so that said mounting portion of said first clip is allowed to rotate about said shoulder portion within said space.

11. The power saw as defined in claim 8, wherein said first cord clip further includes a sleeve portion extending from said mounting portion, said sleeve portion having an opening which flexes to enable said first section of said power cord to be inserted into or taken out of said sleeve.

12. The power saw as defined in claim 8, wherein said cord clip further includes a sleeve portion extending from said mounting portion, said sleeve portion having a pair of spaced tabs which define an opening in said sleeve, and a screw extending through said tabs to secure said first section of said power cord in said sleeve.

13. A power cord routing system for routing a power cord to a motor in a power saw having a linear guide mechanism including at least two links that are connected by a hinge connection and enabling movement of a saw blade and motor assembly along a predetermined linear path in a forward or a rearward direction, said power cord routing system comprising:
a first cord clip rotatably fixed to said hinge connection and configured to receive a first section of said power cord.

14. The power cord routing system as defined in claim 13, further comprising a second cord clip rotatably fixed to a second hinge connection which pivotally connects said saw blade and motor assembly to said linear guide mechanism, said second cord clip being configured to receive a second section of said power cord.

15. The power cord routing system as defined in claim 14, wherein said first and said second cord clips are provided on one end of said first and said second hinge connections on the same side of said linear guide mechanism.

16. The power cord routing system as defined in claim 13, further comprising a second cord clip rotatably fixed to a second hinge connection which operatively connects said linear guide mechanism to a table of said power saw, said second cord clip being configured to receive a second section of said power cord.

17. The power cord routing system as defined in claim 16, wherein said first and said second cord clips are provided on one end of said first and said second hinge connections on the same side of said linear guide mechanism.

18. The power cord routing system as defined in claim 13, further comprising a second cord clip rotatably fixed to a second hinge connection which pivotally connects said saw blade and motor assembly to said linear guide mechanism, and
a third cord clip rotatably fixed to a third hinge connection which operatively connects said linear guide mechanism to a table of said power saw,
wherein said second and said third cord clips are configured to receive a second section of said power cord.

19. The power cord routing system as defined in claim 18 wherein said first, said second and said third cord clips are provided on one end of said first, said second and said third hinge connections on the same side of said linear guide mechanism.

20. A power miter saw having a power cord routing system, comprising:
a rotatable table configured to receive a workpiece;
a pivotable saw blade and motor assembly including a motor for rotating a circular saw blade;
a power cord connected to said motor for supplying electric power to said motor;
a linear guide mechanism operatively connected to said table and being configured to pivotally support said saw blade and motor assembly, said linear guide mechanism enabling movement of said saw blade and motor assembly along a predetermined linear path in a forward or a rearward direction;
said linear guide mechanism including at least two links connected by a first hinge connection; and
a first cord clip rotatably fixed to said hinge connection and configured to receive a first section of said power cord.

21. The power miter saw as defined in claim 20, wherein said linear guide mechanism is pivotally connected to said saw blade and motor assembly by a second hinge connection and operatively connected to said table by a third hinge connection,
a second cord clip is rotatably fixed to one end of said second hinge connection, and
a third cord clip is rotatably fixed to one end of said third hinge connection,
wherein said second and said third cord clips are configured to receive a second section of said power cord and are provided on the same side of said linear guide mechanism.
